(19) United States
(12) Patent Application Publication
(10) Pub. No.: US 2002/0142827 A1
(43) Pub. Date: Oct. 3, 2002

(54) Gaming machine, gaming interruption method and program for executing the method

(75) Inventors: Eiji Aida, Tokyo (JP); Koji Kazaoka, Tokyo (JP)

Correspondence Address: SUGHRUE, MION, ZINN, MACPEAK & SEAS, PLLC, 2100 Pennsylvania Avenue, N.W., Washington, DC, 20037, US

(73) Assignee: KONAMI CORPORATION

(21) Appl. No.: 10/105,398

(22) Filed: Mar. 26, 2002

(30) Foreign Application Priority Data
Mar. 27, 2001 (JP) P. 2001-089556

(51) Int. Cl. A63F 13/00

(52) U.S. Cl. 463/20

(57) ABSTRACT

In a gaming machine provided with operating members actuated by human, a game processor proceeds a game in accordance with the actuation of the operating members. An inhibition requirement determinant determines whether a predetermined inhibition requirement is satisfied while the game processor proceeds the game. A game inhibiter performs game inhibition processing for diverting an attention of the player toward something other than the game, when the inhibition requirement determinant determines that the inhibition requirement is satisfied. A game interrupter interrupts the game proceeded by the game processor, when the inhibition requirement determinant determines that the inhibition requirement is satisfied. The game interrupter interrupts the game until a predetermined interruption canceling requirement is satisfied.

### BACKGROUND OF THE INVENTION

The present invention relates to a gaming machine having operating members to be actuated by a player and a game processor for proceeding a game in accordance with the nature of actuation of the operating members, and relates to a gaming interruption method for inhibiting a player from excessively and continuously playing a game on the gaming machine, and a computer program for executing the method.

Gaming machines of this type include a variety of types, such as home TV gaming machines, commercial gaming machines installed in amusement arcades, and slingshot machines and slot machines installed in parlors. Gaming machines which enable direct acceptance and payout of cash are installed in officially-recognized overseas gambling facilities. Since a player can indulge in playing games while being oblivious to passage of time, the gaming machines are utilized as entertainment for enjoying leisure.

However, when the player has excessively indulged in playing games, he/she loses a sense of reality. As a result, the player may continue playing games while forgetting scheduled activities or canceling the activities. Particularly, gaming machines aimed at acquiring money or prizes, so-called gambling gaming machines, often involve a player overly indulging in games, thereby resulting in the danger of the player becoming addicted to gambling. As a technique for preventing excessive indulgence in games, there have been known gaming machines which disconnect power to thereby forcibly terminate games after a player has played games for a given time period (see Japanese Utility Model Application No. 6-63089U and Japanese Patent Application No. 7-299248A).

These gaming machines forcibly terminate games merely after lapse of a given time period, regardless of the level of indulgence of a player. Mere forcible termination of games fails to cause a player to realize that he/she has overly indulged in games. Hence, the player cannot regain a sense of reality. For this reason, there is a high probability of a player resuming games on another gaming machine after forcible termination of the game, thus failing to effectively inhibit excessive gaming.

### SUMMARY OF THE INVENTION

It is therefore an object of the present invention to provide a gaming machine, and a gaming interruption method which can effectively inhibit excessive gaming, and a computer program which executes the method.

In order to achieve the above object, according to the present invention, there is provided a gaming machine, comprising:

operating members actuated by human;

a game processor, which proceeds a game in accordance with the actuation of the operating members;

an inhibition requirement determinant, which determines whether a predetermined inhibition requirement is satisfied while the game processor proceeds the game;

a game inhibiter, which performs game inhibition processing for diverting an attention of the player toward something other than the game, when the inhibition requirement determinant determines that the inhibition requirement is satisfied; and

a game interrupter, which interrupts the game proceeded by the game processor, when the inhibition requirement determinant determines that the inhibition requirement is satisfied, the game interrupter interrupting the game until a predetermined interruption canceling requirement is satisfied.

In the gaming machine, so long as the gaming inhibition requirement is set appropriately to such an extent that excessive play is prevented, the player regains a sense of reality when the gaming inhibition requirement has been satisfied. Hence, the player becomes aware that he/she has become overly indulged in games. Here, when the predetermined game inhibition requirement has been satisfied, the player undergoes game inhibition processing while the current round of game is interrupted.

Preferably, the gaming machine further comprises a timer which measures a time period that the game interrupter interrupts the game. The interruption canceling requirement is that the timer measures a predetermined time period.

In the gaming machine, a game can be interrupted until an effect of inhibiting game stemming from the game inhibition processing performed by the game inhibiter is sufficiently exhibited, by appropriately setting a predetermined time period. For example, when there is performed game inhibition processing for displaying a warning message for excessive play, a time during which an ordinary player can sufficiently understand the nature of the warning upon receipt of the warning message is set as the predetermined time period.

Preferably, the operating members include an inhibition canceller. The interruption canceling requirement is that the inhibition canceller is actuated.

In the gaming machine, for example, after the player has given up continuing the game as a result of the game inhibition processing, an operator of a parlor or arcade where the gaming machine is installed cancels the interruption of the game, thereby enabling another player can use the gaming machine.

Preferably, the operating members include a game starter which instructs the game processor to start proceeding the game. The game interrupter includes an operation canceller which cancels the instruction of the game starter.

In the gaming machine, since the player who has satisfied the predetermined game inhibition requirement cannot actuate the game starter, the game interruption can be surely conducted.

Preferably, the gaming machine further comprises a gaming value accepter which accepts a gaming value from a player. The game processor proceeds the game while consuming the gaming value. The game interrupter includes an acceptance refuser which refuses to accept a gaming value from the player via the gaming value accepter.

Here, the expression “gaming value” means values to be paid by a player into a gaming machine for playing games. The gaming value includes medals, tokens, or coins (or bills). Further, the expression “gaming value” includes tangible substances or intangible substance equivalent to the tangible substances, such as electronic data.

In the gaming machine, since the player can be directly inhibited from spending money for games by setting the amount of gaming value, as required, the game interruption can be surely conducted.

Preferably, the gaming machine further comprises a sound generator which generates sound for presenting the game proceeded by the game processor. The game interrupter includes a sound inhibiter which disables the sound generation of the sound generator.

In the gaming machine, termination of presentation sound imparts a consciousness of difficulty to continue game to the player.

Preferably, the gaming machine further comprises a light emitter which emits light for presenting the game proceeded by the game processor. The game interrupter includes an illumination inhibiter which disables the light emission of the light emitter.

In the gaming machine, stoppage of illumination for presentation purpose imparts a consciousness of difficulty to continue game to the player. Thus, an effect of inhibiting excessive game can be enhanced.

Preferably, the gaming machine further comprises:

a gaming value recording medium, which stores therein an amount of a gaming value possessed by a player; and

a payout provider, which provides a payout to the player, the payout being a gaming value corresponding to the amount of the gaming value stored in the gaming value recording medium.

The operating members includes a payout requester which instructs the payout provider to provide the payout. The payout requester and the payout provider are enabled even when the game interrupter interrupts the game.

In the gaming machine, even when game remains in an interrupted state, the player can receive a refund of gaming value recorded on the gaming value recording medium, by actuation of the payout requester to quit the game. As a result, the player to smoothly give up the gaming machine for another player.

According to the present invention, there is also provided a method of interrupting a game performed in a gaming machine to inhibit an excessive play of a player on the gaming machine, comprising the steps of:

proceeding the game on the gaming machine;

determining whether a predetermined inhibition requirement is satisfied while the game is proceeded;

diverting an attention of the player toward something other than the game, when the inhibition requirement is satisfied;

interrupting the game when the inhibition requirement is satisfied; and

interrupting the game until a predetermined interruption canceling requirement is satisfied.

Preferably, the game interruption method further comprises the step of measuring a time period that the game is interrupted. The interruption canceling requirement is that a predetermined time period is measured.

According to the present invention, there is also provided a program for causing a computer to execute the above game interruption method.

The program is distributed or available while recorded on a recording medium, such as a CD-ROM. So long as a program is superimposed on a signal and the signal is transmitted or received by a predetermined transmitter by way of a public phone line, a private line, or a transmission medium, such as another communication network, the program can be distributed and acquired. The only requirement is that at least a portion of the program be transmitted over the transmission medium during the course of transmission. In short, there is no necessity for all the data constituting the program being temporarily located in the transmission medium. A signal having the program superimposed thereon is a computer data signal embodied in a predetermined carrier wave including a program. Further, a method of transmitting a program from a predetermined transmitter includes a case where data constituting a program are transmitted continuously and a case where the data are transmitted intermittently.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a flowchart showing flow of excessive gaming inhibition processing to be performed in a slot machine according to a first embodiment of the present invention;

FIG. 2 is an external perspective view of the slot machine;

FIG. 3 is a block diagram schematically showing the configuration of a main controller of the slot machine;

FIG. 4 is a block diagram schematically showing the configuration of a sub-controller of the slot machine;

FIG. 5 is a flowchart showing flow of excessive gaming inhibition processing according to a second embodiment of the invention;

FIG. 6 is a flowchart showing flow of excessive gaming inhibition processing according to a third embodiment of the invention;

FIG. 7 is a flowchart showing flow of excessive gaming inhibition processing according to a fourth embodiment of the invention;

FIG. 8 is a flowchart showing flow of excessive gaming inhibition processing according to a fifth embodiment of the invention;

FIG. 9 is a flowchart showing flow of excessive gaming inhibition processing according to a sixth embodiment of the invention;

FIG. 10 is a flowchart showing flow of excessive gaming inhibition processing according to a seventh embodiment of the invention;

FIG. 11 is a flowchart showing flow of excessive gaming inhibition processing according to an eighth embodiment of the invention;

FIG. 12 is a flowchart showing flow of excessive gaming inhibition processing according to a ninth embodiment of the invention;

FIG. 13 is a block diagram schematically showing the configuration of a main controller of a slot machine according to a tenth embodiment of the invention; and

FIG. 14 is a flowchart showing flow of excessive gaming inhibition processing to be performed in the slot machine of FIG. 13.

### DETAILED DESCRIPTION OF THE PREFERRED EMBODIMENTS

There will now be described a first embodiment in which the present invention is applied to a slot machine or a symbol-match gaming machine. A slot machine to be described in the present embodiment is a video slot machine installed in a casino or the like.

The basic configuration of a slot machine according to the present embodiment will now be described.

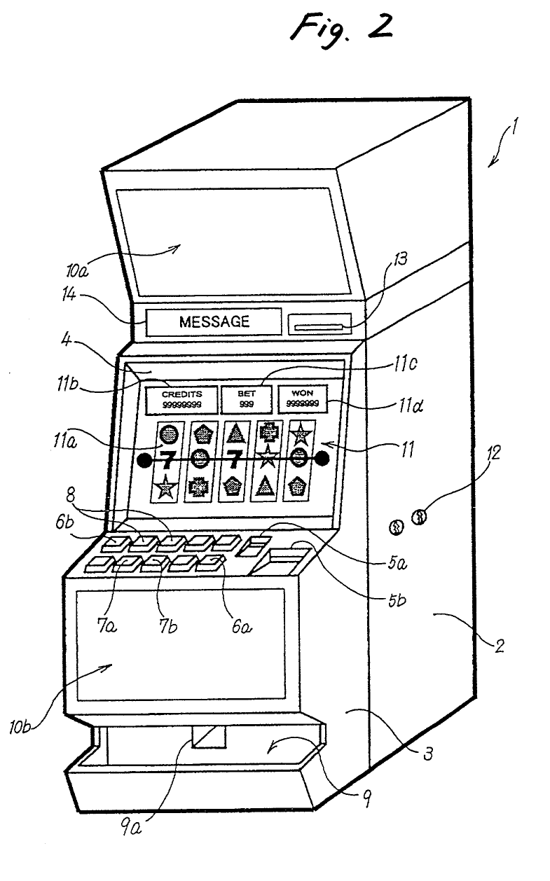

FIG. 2 is an external perspective view of a slot machine according to the first embodiment. The slot machine 1 has a box-shaped housing 2 and a front panel 3 reclosably attached to a front side of the housing 2. The front panel 3 has a display window 4 for visually viewing, from the outside, a monitor 11 serving as a variable game screen display; a coin insertion slot 5a and a bill insertion slot 5b constituting a gaming value accepter; a play button 6a serving as a game starter; a reimbursement button 6b serving as a payout requester; BET buttons 7a and 7b used by a player to insert coins into a slot machine; a coin receiver 9 having a coin refund port 9a; and lamps 10a and 10b serving as a light emitter. The play button 6a, the credit reimbursement button 6b, the BET buttons 7a and 7b, and the other operation button 8 are embodied as lamp buttons equipped with light emitters.

The monitor 11 for displaying five reel images (play screens) 11a, on which a plurality of types of symbols sequentially appear, is provided in the slot machine 1. The monitor 11 is composed of a CRT display but may be constituted of a plasma display or a liquid-crystal display. In a position located above the reel images 11a of the monitor 11 are displayed a credit display section 11b for displaying the sum of credit equivalent to the amount of money, or gaming values, inserted by the player by way of the coin insert slot 5a or the bill insertion slot 5b; a BET display section 11c for displaying the amount of bets placed by the player by actuation of the BET buttons 7a and 7b; and an acquired amount display section 11 d for displaying the amount of money acquired by the player as a result of a game.

Built into the slot machine 1 are an inspection apparatus for checking whether or not accepted coins or bills are genuine, an unillustrated coin refunding device having a hopper capable of receiving a plurality of coins, a speaker serving as a sound generator or a presentation sound generator, and a circuit board in which an electronic circuit is formed from electronic components, such as a CPU, ROM, or other electronic components to constitute a controller.

A reset button 12 serving as a game inhibition releaser is provided on the side of the slot machine 1. The reset switch 12 has a keyway corresponding to a specialized key possessed by an attendant of the casino where the slot machine 1 is installed. The reset switch 12 is actuated by inserting the specialized key into the keyway. Thus, a player cannot actuate the reset switch 12.

A card insertion slot 13 for enabling insertion of a house card serving as a carriable recording medium to be used in a casino and a display device 14 are provided in an upper section of the slot machine 1. The house card is for managing personal information about a player registered at a reception desk of the casino. The house card has recorded thereon an ID, which is identification information unique to an individual player. A casino management system manages personal information about each player in association with an ID. The house card is utilized for the management system to manage points corresponding to the amount of money spent by the player in the games. In accordance with points owned, a bonus, such as a free hotel coupon, can be afforded to a player. The display device displays points owned by the player.

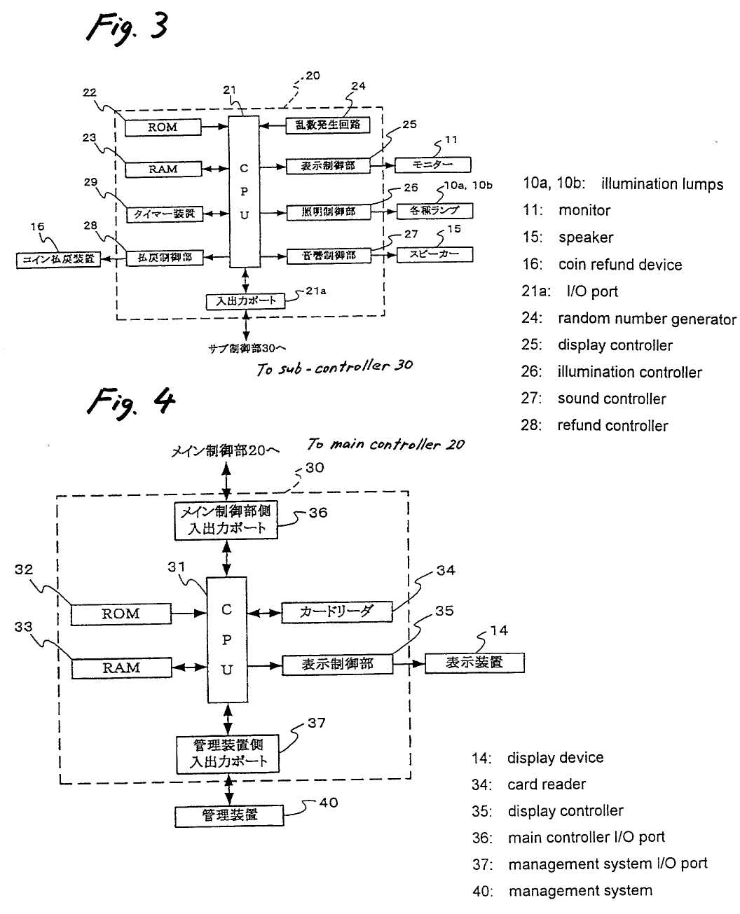

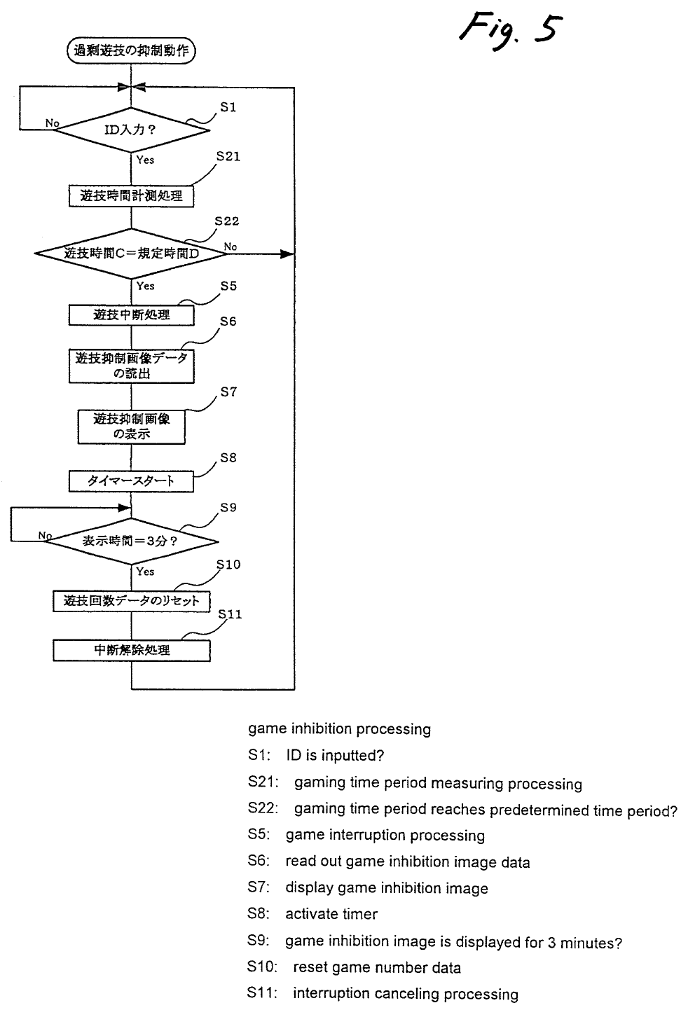

FIG. 3 is a block diagram schematically showing the configuration of a main controller 20 in the controller of the slot machine 1. FIG. 4 is a block diagram schematically showing the configuration of a sub-controller 30 which constitutes the controller together with the main controller 20.

The main controller 20 comprises a CPU 21, an I/O port 21 a, ROM 22, RAM 23, a random number generator 24, a display controller 25, an illumination controller 26, a sound controller 27, a refund controller 28, and a timer 29. The I/O port 21a is utilized for establishing data communication with the sub-controller 30. The ROM 22 stores data to be utilized by the CPU 21, such as various programs and databases, and outputs the data to the CPU 21. The RAM 23 temporarily stores variable-number data computed by the CPU 21. The random number generator 24 produces a random number at a predetermined cycle and outputs to the CPU 21 data pertaining to the thus-produced random number. Under control of the CPU 21, the display controller 25 controls displaying operation of the monitor 11 which displays the reel images 11a. Under control of the CPU 21, the illumination controller 26 controls illumination of the lamps 10a and 10b. Under control of the CPU 21, the sound controller 27 controls a voice announcement or presentation sound output from a speaker 15. Under control of the CPU 21, the refund controller 28 controls the coin refund device 16 serving as a payout provider for refunding coins to the coin receiver 9 by way of the coin refund port 9a. Under control of the CPU 21, the timer 29 measures a time period and outputs a measurement result to the CPU 21.

The CPU 21 of the main controller 20 is connected to the play button 6a, the credit reimbursement button 6b, the BET buttons 7a and 7b, and the other operation buttons 8. The CPU 21 is connected also to an money counter serving as an unillustrated gaming value counter for counting coins inserted by way of the coin insertion slot 5a or a bill inserted by way of the bill insertion slot 5b.

The sub-controller 30 is constituted of a CPU 31, a ROM 32, a RAM 33, a card reader 34 serving as an identification information reader, a display controller 35, a main controller I/O port 36, and a management system I/O port 37. The ROM 32 stores data to be utilized by the CPU 31, such as programs or databases, and outputs the data to the CPU 31. The RAM 33 temporarily stores variable-number data computed by the CPU 31. The card reader 34 reads an ID recorded on a house card inserted by way of the card insertion slot 13. The thus-read ID is output to the CPU 31. Under the control of the CPU 31, the display controller 35 controls display operation of the display device 14. The main controller I/O port 36 is utilized for establishing data communication with the main controller 20. The management system I/O port 37 is utilized for establishing data communication with a management system 40 which collectively manages a plurality of gaming machines installed in a casino.

In accordance with flow of a game performed by the slot machine 1, operations of individual sections will be described.

When a player inserts unillustrated coins into the coin insertion slot Sa or a bill into the bill insertion slot 5b, the unillustrated money counter counts the coins or bill. The money counter outputs inserted amount data to the CPU 21 of the main controller 20. The CPU 21 that has received inserted amount data acts as a gaming value recorder and records credit data (gaming value) corresponding to the inserted amount data into the RAM 23 serving as a gaming value recording medium.

When having decided a desired amount to bet, the player actuates the predetermined BET buttons 7a and 7b. Data pertaining to the actuation of the BET buttons 7a and 7b are sent as a predetermined operation signal to the CPU 21 of the main controller 20. The CPU 21 performs processing for decreasing from credit data stored in the RAM 23 credits corresponding to the operation signal. The CPU 21 becomes able to accept an operation signal from the play button 6a, thus rendering operation of the play button 6a performed by the player effective.

When the player has actuated the play button 6a, a result of operation is sent to the CPU 21 of the main controller 20 as an operation signal. Having received the operation signal, the CPU 21 acts as a game processor. First, the CPU 21 receives five sets of data pertaining to random numbers sent from the random number generator 24. The random numbers correspond to the respective reel images 11a appearing on the monitor 11. The CPU 21 checks the random numbers against a symbol table stored in the ROM 22. The symbol table is provided for each of the reel images 11a. The CPU 21 outputs to the display controller 25 the random numbers and displayed symbol data acquired from the respective symbol tables. As a result, after having displayed on the monitor 11 reel images whose symbols are variably displayed, the display controller 25 performs display control operation for stopping, at the corresponding reel images, symbols corresponding to the respective displayed symbol data sent from the CPU 21.

The CPU 21 performs winning determination processing for checking a combination of five random numbers sent from the random number generator 24 against a winning determination table stored in the ROM 22. The winning determination table is used for associating a combination of five random numbers with a winning combination. As winning combinations, there are prepared a combination for paying off a predetermined amount of credits to the player, and a combination for shifting the current round of game to a special game status, such as an event, a bonus game, or a feature game. By reference to a combination of random numbers and a winning determination table, the CPU 21 specifies a winning combination hit in the present round of game or a failure when no winning combination is constituted.

When a winning combination for paying a predetermined amount of credit to a player is determined to have hit through the winning determination processing, after the reel images 11a appearing on the monitor 11 have been stopped, the CPU 21 of the main controller 20 outputs a predetermined presentation signal to the illumination controller 26 and the sound controller 27. As a result, the illumination controller 26 performs illumination control operation for causing the lamps 10a and 10b remaining in an illuminated state to blink in a blink pattern corresponding to the presentation signal. The sound controller 27 performs control operation for temporarily suspending sound output from the speaker 15 as presentation sound and causing the speaker 15 to output a sound effect corresponding to a presentation signal. The CPU 21 acts as a gaming value payout provider to perform payout operation for adding to the credit data recorded in the RAM 23 credit corresponding to the winning combination.

When a winning combination for shifting the current round of game to an event, a bonus game, or a feature game is determined to have hit through the winning determination processing, after the reel images 11a appearing on the monitor 11 have been stopped, the CPU 21 of the main controller 20 outputs a predetermined presentation signal to the illumination controller 26 and the sound controller 27. As a result, the illumination controller 26 performs illumination control operation for causing to blink, in a blink pattern corresponding to the presentation signal, the lamps 10a and 10b and the spin button 6, all remaining in an illuminated state, the credit reimbursement button 6b, the BET buttons 7a and 7b by way of which the player pays coins to the slot machine, and a lamp button equipped with the light emitter of the other operation button 8. Further, the sound controller 27 performs control operation for temporarily suspending sound output from the speaker 15 as presentation sound and causing the speaker 15 to output a sound effect corresponding to a presentation signal. The CPU 21 acts as a game status changer for changing the current mode of game; i.e., a general game status, to a special game status such as an event or bonus game corresponding to a winning combination.

The slot machine 1 according to the present embodiment converts the credit spent by the player into points and provides various services to the player in accordance with the points. The player who desires to receive the service registers at the reception desk of the casino, where the slot machine 1 is installed, before playing a game on the slot machine 1. Through the registration processing, personal information; e.g., the name and address of a player, is filled into a predetermined form. The player receives a house card having printed thereon an ID unique to the player. The personal information filled in the form is registered into the database stored in the management system 40 by way of a predetermined terminal.

The player who has received the house card in this way inserts the house card into the card insertion slot 13 before commencing a game on the slot machine 1. The card reader 34 of the sub-controller 30 reads an ID recorded on the thus-inserted house card. The thus-read ID is sent to the CPU 31. The CPU 31 sends to the management system 40 the ID that has been received from the card reader 34, by way of the management system I/O port 37, thereby receiving point data pertaining to the ID. A player who utilizes a house card for the first time receives point data of “0.” In contrast, a player who has utilized the house card in the past receives the point data stored through the games played in the past. After having temporarily stored the point data into the RAM 33, the CPU 31 that has received the point data outputs to the display controller 35 a display instruction corresponding to the point data. The display controller 35 performs display control operation for displaying the point as character information on the display device 14.

Every time the player plays a game on the slot machine 1, the CPU 21 of the main controller 20 outputs, to the sub-controller 30 by way of the I/O port 21a, credit consumption data pertaining to the amount of credit recorded in the RAM 23. The credit consumption data are input to the CPU 31 by way of the main controller I/O port 36 of the sub-controller 30. As a result, the CPU 31 converts the credit consumption data into points and adds the points to the point data stored in the RAM 33. The point data to which the points have been added are displayed on the display device 14 at all times. By way of the management system I/O port 37, the CPU 31 outputs data corresponding to the points to the management system 40 along with the ID. Having received the point data, the management system 40 adds the point data to the point data registered in the database in association with the ID.

The point data which are registered in the database of the management system 40 in this manner can be converted into a service corresponding to the points at the reception desk of the casino at the player's wishes.

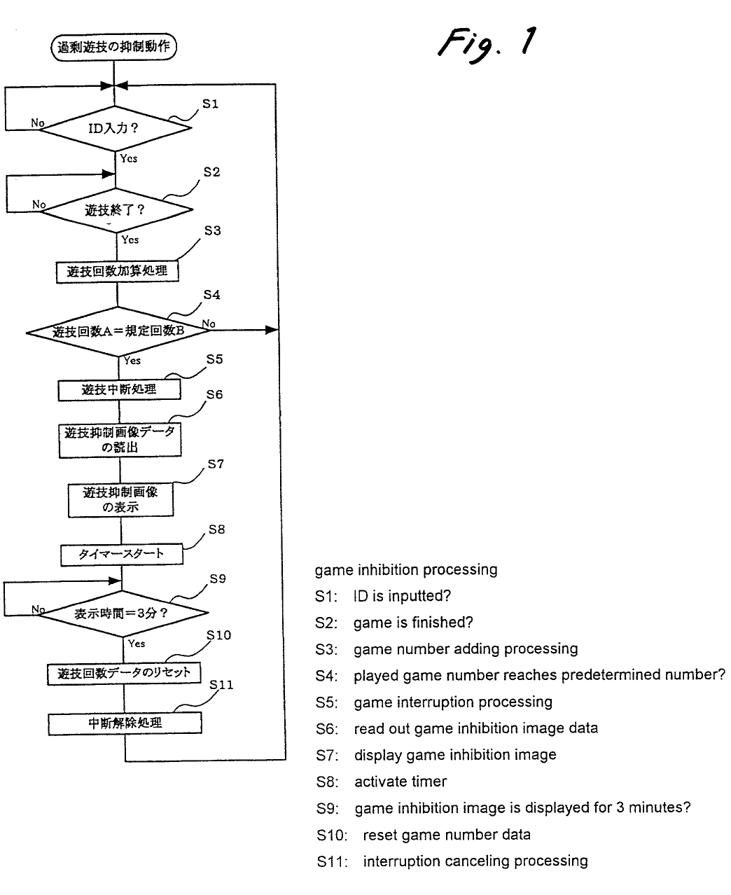

Operation for inhibiting excessive gaming of a player will now be described. FIG. 1 is a flowchart showing the flow of operation for inhibiting excessive play according to the present embodiment.

First, when a player inserts his/her house card into the card insertion slot 13, the ID read by the card reader 34 is input to the CPU 21 of the main controller 20 for each game (S1). The time when the house card is inserted into the card insertion slot 13 is taken as a predetermined reference time, and game inhibition processing is started. The CPU 21 acts as a game number counter. When a game is completed as a result of the reel images 11a appearing on the monitor 11 having stopped (S2), the CPU 21 performs game number addition processing for adding “1” to the game number data recorded on the RAM 23 (S3). After having performed the game number addition processing in each game, the CPU 21 acts as an inhibition requirement determinant. The CPU 21 determines whether or not the number of games A pertaining to the game number data has reached a preset number of times (i.e., a predetermined number of times) B (S4). When the number of games A is determined not to have reached the specified number of times B through the determination processing pertaining to step S4, processing then returns to step S1. The next game is performed in the same manner. In contrast, when the number of games A is determined to have reached the specified number of times B, the CPU 21 acts as a game inhibiter together with the display controller 25, thereby performing game inhibition processing.

First, the CPU 21 acts as a game interrupter or an operation canceller through the game inhibition processing according to the present embodiment, thereby performing gaming interruption processing (S5). As a result, the CPU 21 becomes unable to receive an operation signal output from the play button 6a. As a result, the player cannot start a game even by actuating the play button 6a. The CPU 21 outputs an acceptance refusal instruction to the unillustrated money counter, thereby causing the money counter to act as an acceptance refuser. Thus, counting of inserted coins or bill is nullified. Even when the player inserts a coin by way of the coin insertion slot 5a, the thus-inserted coin is not counted as a credit and is refunded by way of the coin receiver 9. Further, in the same manner, even when a bill is inserted by way of the bill insertion slot 5b, the thus-inserted bill is not counted as a credit. Hence, the bill is refunded by way of the bill insertion slot 5b.

The CPU 21 of the main controller 20 outputs a sound stop instruction to the sound controller 27. Then, the sound controller 27 acts as a sound inhibiter, thereby stopping the sound generation from the speaker 15. The CPU 21 outputs a turn-off instruction to the illumination controller 26, so that the illumination controller 26 acts as an illumination inhibiter and extinguishes the lamps 10a and 10b and the spin button 6, all remaining in an illuminated state or a blinked state, the credit reimbursement button 6b, the BET buttons 7a and 7b by way of which the player pays coins to the slot machine, and a lamp button equipped with the light emitter of the other operation button 8.

Until the interruption is canceled, the CPU 21 of the main controller 20 remains able to accept an operation signal output from the credit reimbursement button 6b. Hence, if the player actuates the credit reimbursement button 6b during the course of a game being interrupted, the CPU 21 receives the operation and outputs a refund instruction to the refund controller 28 along with the credit amount data recorded in the RAM 23. As a result, the refund controller 28 controls the coin refund device 16, thereby ejecting coins corresponding to the received credit amount data to the coin receiver 9 by way of the coin payout port 9a.

The CPU 21 of the main controller 20 loads game inhibition image data stored in the ROM 22 (S6). The game inhibition image data are sent to the display controller 25 as a game inhibition image display controller. The display controller 25 converts the game inhibition image based on the game inhibition image data into reel images 11a and displays the game inhibition image on the monitor 11 in lieu of the reel images 11a (S7). As a result, the game inhibition image appears in the area on the monitor 11 where the reel images 11a have been displayed. The game inhibition image may be a stationary or moving image which can cause the player to divert his/her consciousness to anything other than a game. Preferably, the game inhibition image can lead the player to terminate the game.

As a game inhibition image to be displayed on the monitor 11, a moving image, such as a motion picture, or a stationary image, such as a photograph of nature, may be employed. If an attempt is made to actively stop the player who is excessively playing games, a game inhibition message for inhibiting the player from playing games may be may be reported to player as an alarm. In this case, for example, a warning message about excessive play is displayed on the monitor 11 serving as a game inhibition message provider, in place of the game inhibition image of a motion picture. A statement certified by a public organization relating to inhibition of excessive play may be used as a warning message. Displaying a seal of the public organization along with the warning message is likely to be effective.

In the present embodiment, displaying a game inhibition image on the monitor 11 enables separation of the consciousness of the player from games, thereby inhibiting excessive play. In addition to a method of visually inhibiting excessive play, there may also be utilized a method of audibly separating the consciousness of the player from games, thereby inhibiting excessive play. For example, sound information about a warning announcement is recorded on the ROM 22 of the main controller 20. Under control of the CPU 21, which performs game inhibition processing, the sound controller 27 may outputs the warning announcement from the speaker 15. In this case, the warning announcement may be heard by other players playing on gaming machines installed around the slot machine 1, casino attendants, and other persons. Hence, this method is very effective for inhibiting the player who is playing games excessively from continuing games. In place of the warning announcement, warning sound or music may be output.

In the present embodiment, when display of the game inhibition image is started through the game inhibition processing, the timer 29 of the main controller 20 starts measuring a time period during which the game inhibition image is displayed (S8). The CPU 21 of the main controller 20 determines whether or not an interruption cancellation requirement; that is, the display time period measured by the timer 29 having reached three minutes, is achieved (S9). When it is determined that the display time period has reached three minutes, the CPU 21 resets the game number data recorded in the RAM 23 to “0” (S10). Further, the CPU 21 becomes able to accept an operation signal output from the play button 6a and outputs an acceptance enable instruction to the unillustrated money counter. As a result, the slot machine 1 returns to a status that had been effective before the game was interrupted (S11).

In the present embodiment, the display time period employed as an interrupt cancellation requirement is three minutes. However, the time may be set in accordance with a time during which a game inhibition image is displayed or with the contents of the image, as required. When a warning message or announcement is issued to a player, it is desirable to ensure a time during which the player can sufficiently understand the nature of the warning upon receipt of the warning message or announcement.

In the present embodiment, the number of games is counted while the time at which a house card is inserted is taken as a reference time. However, in the case of the slot machine 1 which enables a player to play games without utilization of a house card, the slot machine 1 cannot inhibit a player who does not have any house card from playing games excessively. In this case, a game inhibition start button to be actuated by a player before the player starts playing games may be provided on the slot machine 1. In this case, on the basis of autonomy of a player who keeps in mind a potential risk of excessively indulging in games, the player actuates the game inhibition start button before becoming involved in games. The time at which the button has been actuated may be taken as a reference time.

In the present embodiment, when a specified number of games have ended after the player has started playing games by utilization of a house card, a game inhibition image appears on the monitor 11. During interruption of game, the presentation sounds goes out, and the lamps 10a and 10b and the spin button 6, the BET buttons 7a and 7b by way of which the player pays coins to the slot machine for game, and a lamp button equipped with the light emitter of the other operation button 8. The consciousness of the player who is enthusiastically playing games concentrates on the game inhibition image upon glancing the image and can recover the sense of reality. Thus, the player successfully regains self-control, and hence it is possible to prompt the player to stop games.

The above embodiment has described a case where game inhibition processing is performed when the number of games A has reached a specified number of times B. There will now be described a second embodiment of the invention utilizing a play time period C in place of the number of games A. The present embodiment is identical with the first embodiment, except that the play time period C is utilized in place of the number of games A. Only a unique portion of this embodiment will now be described.

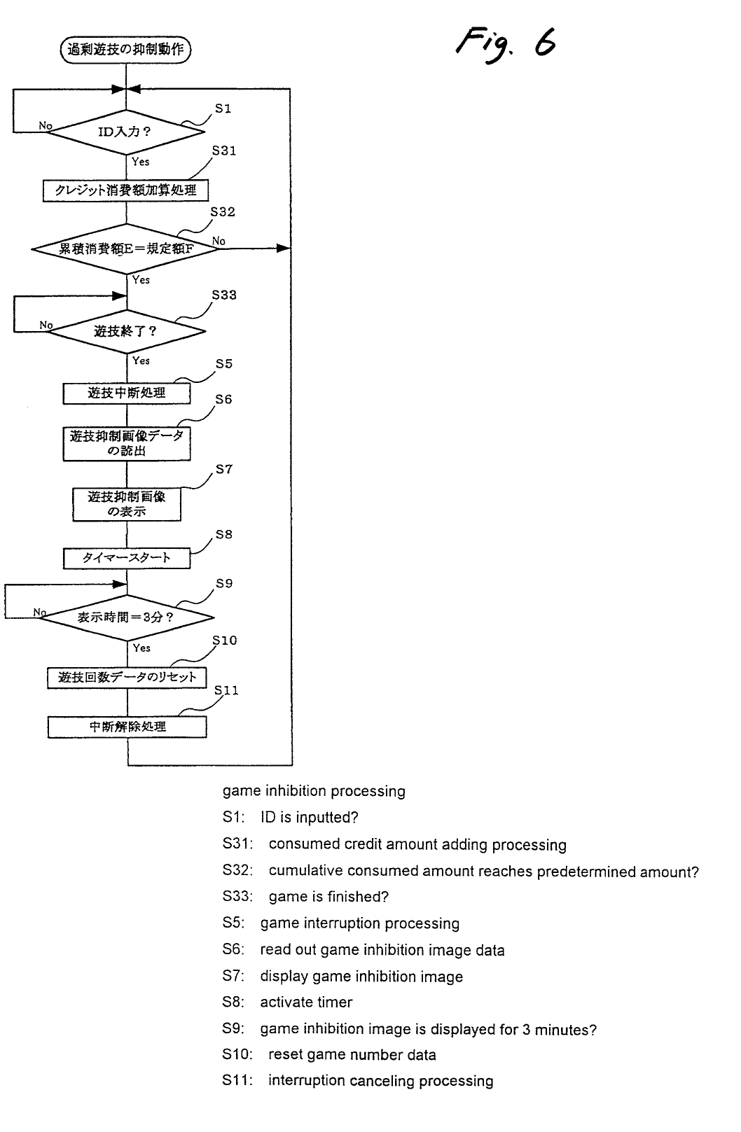

FIG. 5 is a flowchart showing the flow of excessive gaming inhibition processing according to this embodiment.

The player inserts a house card into the card inset slot 13, and the ID read by the card reader 34 is input to the CPU 21 of the main controller 20 (S1). The CPU 21 performs processing for measuring a time period in which the game is played (S21). Through the processing, a measurement instruction for measuring a specified time period is output to the timer 29. The timer 29 measures a time which elapses until a specified time period is achieved since the timer received the measurement instruction. When a specified time period D has been achieved, the timer 29 outputs a measurement end signal to the CPU 21. The CPU 21 acts as an inhibition requirement determinant. Upon receipt of the measurement end signal from the timer 29, the CPU 21 determines that a game inhibition requirement; that is, the play time period C having achieved the specified time period D, is satisfied (S22). After the play time period C is determined to have reached a preset specified time period (predetermined time) D, the CPU 21 performs the gaming interruption processing in the same manner as in the first embodiment (S5) and performs the game inhibition processing (S6).

Next will be described a third embodiment of the invention utilizing an amount of consumed credit E in place of the number of games A. The present embodiment is identical with the first embodiment, except for utilization of the amount of consumed credit E in lieu of the number of games A. Hence, only a unique feature of this embodiment will be described.

FIG. 6 is a flowchart showing the flow of excessive gaming inhibition processing according to this embodiment.

As mentioned above, every time a player plays a game on the slot machine 1, the CPU 21 of the main controller 20 sends, to the management system 40 by way of the sub-controller 30, credit consumption data pertaining to the amount of consumed credit recorded in the RAM 23, thereby performing point addition processing. In this embodiment, the player inserts a house card into the card insertion slot 13, and the ID read by the card reader 34 is input to the CPU 21 of the main controller 20 (S1). Then, the CPU 21 outputs credit consumption data to the sub-controller 30, thereby performing credit consumption addition processing for cumulatively adding the credit consumption data to the RAM 23 (S31). After having performed credit consumption addition processing in each game, the CPU 21 acts as an inhibition requirement determinant. The CPU 21 then determines whether or not a game inhibition requirement; that is, a cumulatively consumed amount E of the accumulated credit consumption data having reached a preset specified amount (predetermined amount) F, has been satisfied (S32). If the cumulatively consumed amount E is determined to have reached the specified amount F, the CPU 21 performs gaming interruption processing (S5) after having ended the game (S33), and then performs game inhibition processing (S6).

Next will be described a fourth embodiment of the invention in which gaming inhibition processing is performed when credits of a player have been depleted. The present embodiment is identical with the first embodiment, except that depletion of credits is employed as a requirement for inhibiting gaming. Hence, only a feature particular to this embodiment will be described.

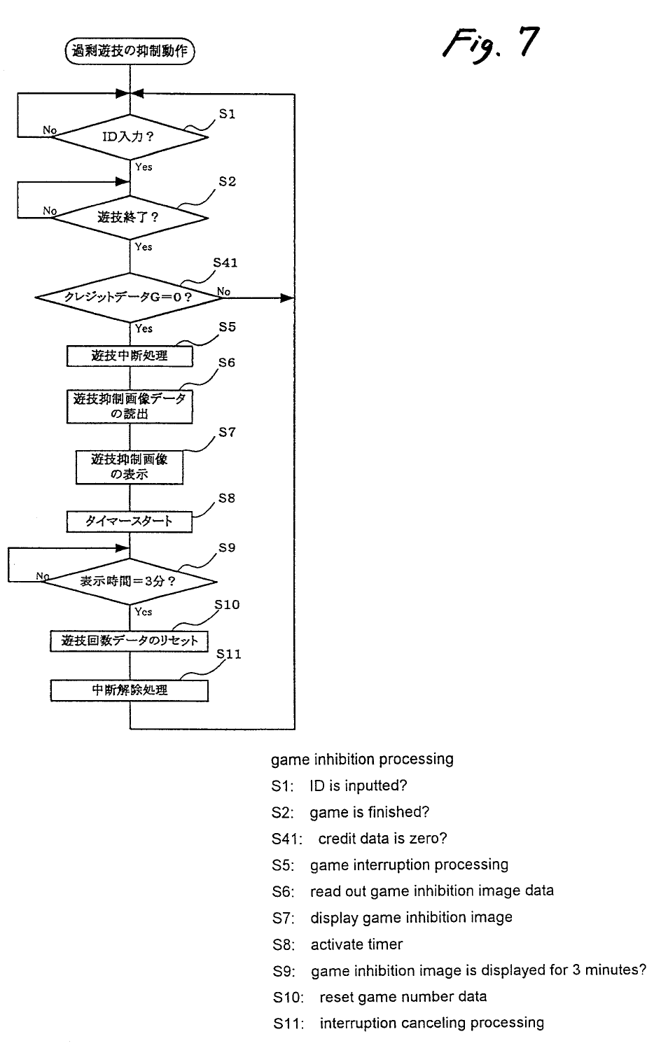

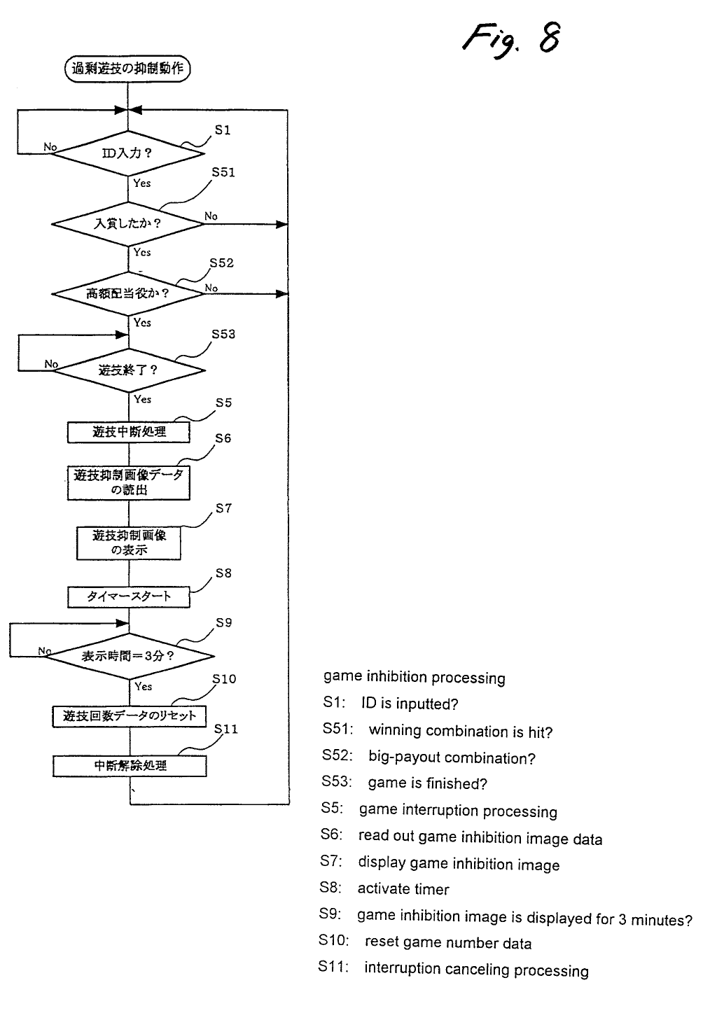

FIG. 7 is a flowchart showing the flow of excessive gaming inhibition processing according to this embodiment.

As mentioned above, when coins are inserted into the coin insertion slot Sa or a bill is inserted into the bill insertion slot 5b, the CPU 21 of the main controller 20 causes the unillustrated money counter to count the coins or bill. A result of counting is recorded in the RAM 23 as credit data G. In this embodiment, the player inserts a house card into the card insertion slot 13, and the ID read by the card reader 34 is input to the CPU 21 of the main controller 20 (S1). Every time one round of games is finished (S2), the CPU 21 acts as an inhibition requirement determinant and determines whether or not the credit data recorded in the RAM 23 assume a value of “0” (S41). When having determined that the credit data G assume a value of “0,” the CPU 21 performs the gaming interruption processing (S5) and then the gaming inhibition processing (S6), in the same manner as in the case of the first embodiment.

Next will be described a fifth embodiment of the invention in which gaming inhibition processing is performed when a big-payoff combination has hit. The present embodiment is identical with the first embodiment, except that winning of a big-payoff combination is employed as a requirement for inhibiting gaming. Hence, only a feature particular to this embodiment will be described.

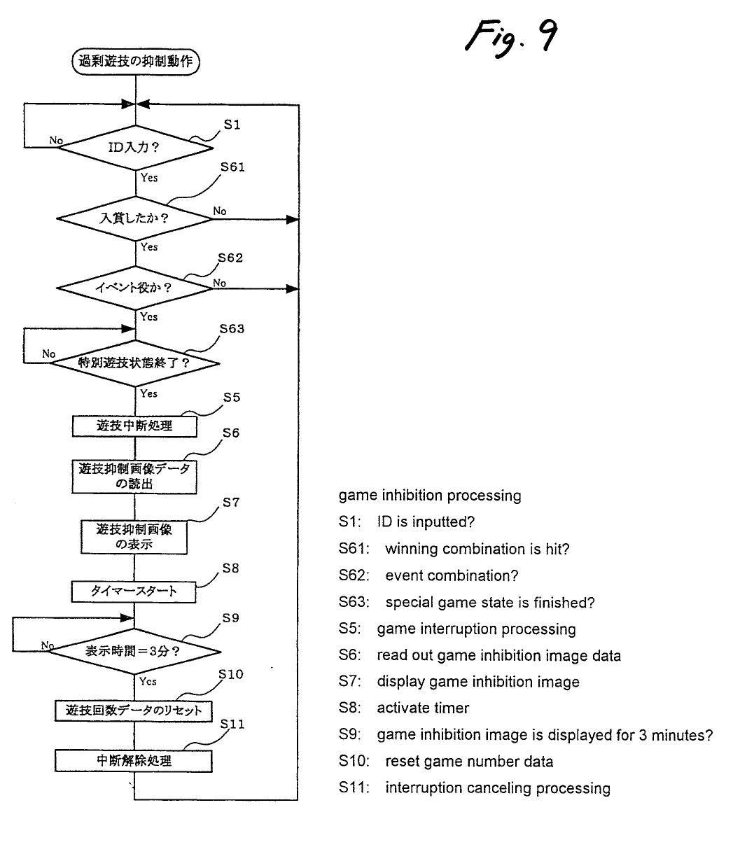

FIG. 8 is a flowchart showing the flow of excessive gaming inhibition processing according to this embodiment.

As mentioned above, when having determined that a combination involving payoff of a predetermined amount of credit to the player has hit, through the winning determination processing, the CPU 21 of the main controller 20 adds to the credit data recorded in the RAM 23 credits corresponding to the thus-hit combination. In the present embodiment, the player inserts a house card into the card insertion slot 13, and the ID read by the card reader 34 is input to the CPU 21 of the main controller 20 (S1). When a combination has hit after winning determination processing performed during a game (S51), the CPU 21 acts as an inhibition requirement determinant and determines whether or not the thus-hit combination is a predetermined big-payoff combination (S52). The big-payoff combination is a combination involving payoff, to the player, of credits which are greater in amount than a preset specified amount of credits (i.e., a predetermined amount of credit). When having determined that the thus-hit combination is a big-payoff combination, the CPU 21 performs gaming interruption processing (S5) after the current round of game has ended (S53). Then, the CPU 21 performs gaming inhibition processing (S6).

Next will be described a sixth embodiment of the invention in which gaming inhibition processing is performed when a combination for shifting the current round of games to an event or bonus game; i.e., a special game status, or a feature game (hereinafter called an “event combination”) has hit, and the event stemming from hitting of the combination has ended. The present embodiment is identical with the first embodiment, except that end of a special game status is employed as a requirement for inhibiting gaming. Hence, only a feature particular to this embodiment will be described.

FIG. 9 is a flowchart showing the flow of excessive gaming inhibition processing according to this embodiment.

As mentioned above, when having determined that there as occurred an event combination involving shift from the current round of games to an event or bonus game; i.e., a special game status, or a feature game, through winning determination processing, the CPU 21 of the main controller 20 causes shift from an ordinary game status to a special game status, such as an event or bonus game corresponding to the kind of the event combination, or a feature game, and proceeds games of the event. In the present modification, the player inserts a house card into the card insertion slot 13, and the ID read by the card reader 34 is input to the CPU 21 of the main controller 20 (S1). When a combination has hit after winning determination processing performed during a game (S61), the CPU 21 determines whether or not the thus-hit combination is an event combination (S62). When having determined that the thus-hit combination is a big-payoff combination, the CPU 21 acts as an inhibition requirement determinant and determines whether or not a special game status stemming from games of the event has ended (S63). If the special game status has ended, gaming interruption processing is performed (S5), and gaming inhibition processing (S6) is performed.

The fifth and sixth embodiments have described a case where gaming inhibition processing is performed when the combination which has hit during the course of gaming played on the slot machine 1 is a big-payoff combination or an event combination. When receiving a wager stemming from a big-payoff combination or event combination, there may be played a gambling game or double-up game for further increasing the wager. Gaming inhibition processing may be performed when the game has ended. When the slot machine 1 is connected to a jackpot system constituted of a plurality of gaming machines, gaming inhibition processing may be effected when the jackpot system has finished payment of a wager.

Next will be described a seventh embodiment of the invention in which gaming inhibition processing is performed when at least one of three gaming inhibition requirements are satisfied. The present embodiment describes a case where three gaming inhibition requirements are employed; that is, a gaming inhibition requirement which is based on the number of games and employed in the first embodiment of the invention; the gaming inhibition requirement which is employed in the fifth embodiment and based on a big-payoff combination; and the gaming inhibition requirement which is employed in the sixth embodiment and based on the event combination.

The present embodiment is identical with the first embodiment, except that a plurality of gaming inhibition requirements are employed. Hence, only a feature particular to this embodiment will be described.

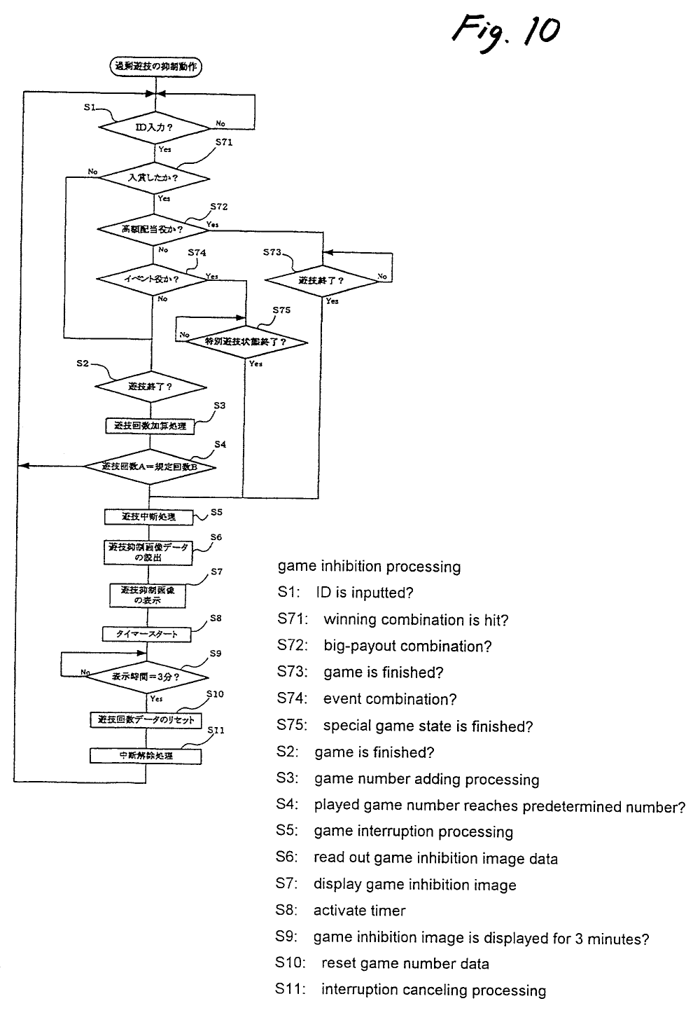

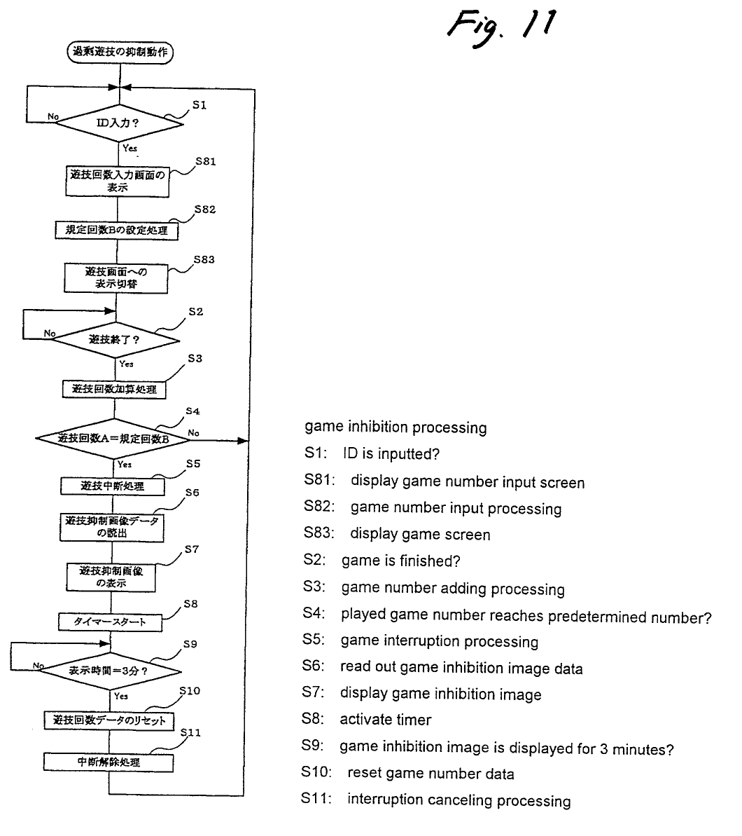

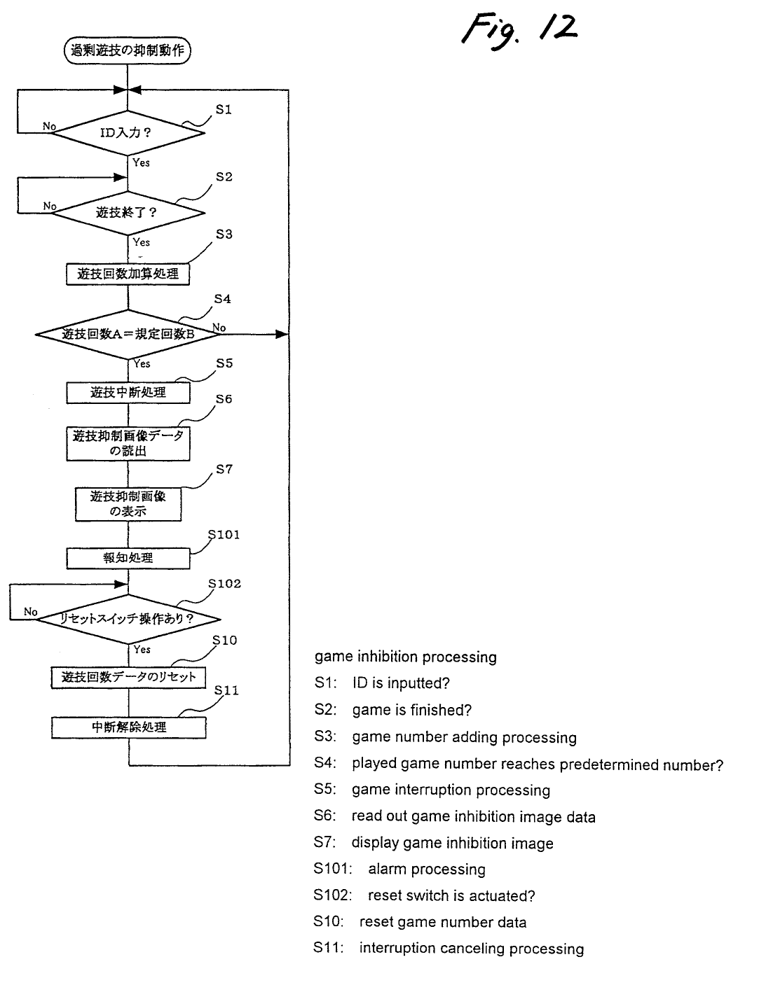

FIG. 10 is a flowchart showing the flow of excessive gaming inhibition processing according to this embodiment.

Here, the player inserts a house card into the card insertion slot 13, and the ID read by the card reader 34 is input to the CPU 21 of the main controller 20 (S1). The CPU 21 of the main controller 20 determines whether or not a winning has hit after winning determination processing performed during a game (S71). If a winning combination has hit, the CPU 21 determines whether or not the thus-hit combination is a big-payoff combination (S72), as in the case of the fifth embodiment. If the thus-hit combination is determined to be a big-payoff combination, the gaming interruption processing is performed (S5) after the current round of games has ended (S73), and the gaming inhibition processing is performed (S6). In contrast, if in step S72 the hit combination is determined not to be a big-payoff combination, a determination is made as to whether or not the hit combination is an event combination (S74), as in the case of the sixth embodiment. If the hit combination is determined to be an event combination, the gaming interruption processing is performed (S5) after the special game status has ended (S75), and the gaming inhibition processing is performed (S6).

If in step S71 it is determined that no winning combination has hit or that the hit combination is neither a big-payoff combination nor an event combination, the game number addition processing is performed (S3) after the current round of games has ended (S2). A determination is made as to whether or not the number of games A has reached the specified number of games B (S4). If the number of games A is determined to have reached the number of games B, the gaming interruption processing is performed (S5), and the gaming inhibition processing is performed (S6).

In the present embodiment, when the gaming inhibition processing ends (S9) after the hit combination has been determined to be a big-payoff combination or event combination (S72 or S74), the CPU 21 of the main controller 20 acts as a resetter and resets to a value of “0” the game number data which have not yet been determined as a gaming inhibition requirement (S10).

The present modification has employed, in combination, the gaming inhibition requirement employed in the first embodiment, that employed in the fifth embodiment, and that employed in the sixth embodiment. There may be arbitrarily combined the gaming inhibition requirements employed in the respective embodiments. Similarly, there may be employed two gaming inhibition requirements or four or more gaming inhibition requirements.

Next will be described an eighth embodiment of the invention in which the specified number of games B can be set in accordance with a player's desire. The present embodiment is identical with the first embodiment in connection with flow of excessive gaming inhibition processing, except that the specified number of games B can be set in accordance with a player's desire. Hence, only a feature particular to this embodiment will be described.

Here, the player inserts a house card into the card insertion slot 13, and the ID read by the card reader 34 is input to the CPU 21 of the main controller 20 (S1). The CPU 21 outputs to the display controller 25 a display instruction for displaying an input screen which prompts the player to enter the number of games to be played. The display controller 25 performs display control operation for displaying an input screen on the monitor 11, and an input screen appears on the monitor 11 (S81). After having determined the number of games to be played, the player enters a desired number of games in accordance with an input screen by actuating the buttons 6a, 6b, 7a, 7b, and 8. The player may enter the number of games directly on the input screen. A plurality of numbers of games may be displayed on the input screen beforehand, and the player may be caused to select one from them. It may be the case that only alternatives, such as “play some games” or “play much,” are displayed on the input screen, and the player is caused to select one from them. In this case, the number of games assigned to each of the alternatives may be recorded in the ROM 22, and the CPU 21 ascertains the number of games.

When in step S81 the player presses the play button 6a after having finished entering the number of games through the game number input processing, the CPU 21 of the main controller 20 acts as a player information receiver and receives game number data which are player information entered by the player. The CPU 21 records the thus-received game number data into the RAM 23 as a specified number of games B (S82). The CPU 21 outputs, to the display controller 25, a display instruction for switching the screen on the monitor 11 to a game screen including the reel images 11a. As a result, the display controller 25 performs a display control operation for causing the monitor 11 to display a game screen, and an ordinary game screen appears on the monitor 11 (S83). Subsequently, the player performs games. Every time one round of games ends (S2), the CPU 21 performs game number addition processing (S3). The CPU 21 then determines whether or not the number of games A pertaining; that is, the game number data acquired through the game number addition processing, has reached the specified number of games B determined by the player (S4). Subsequent processing is the same as that described in the first embodiment.

The first embodiment has been described by reference to a case where the gaming interruption is canceled after the gaming inhibition image is displayed for three minutes. There will now be described a ninth embodiment in which the gaming interruption cannot be canceled without a casino attendant's operation. The present embodiment is identical with the first embodiment in connection with flow of excessive gaming inhibition processing, except that the way of canceling the gaming interruption. Hence, only a feature particular to this embodiment will be described.

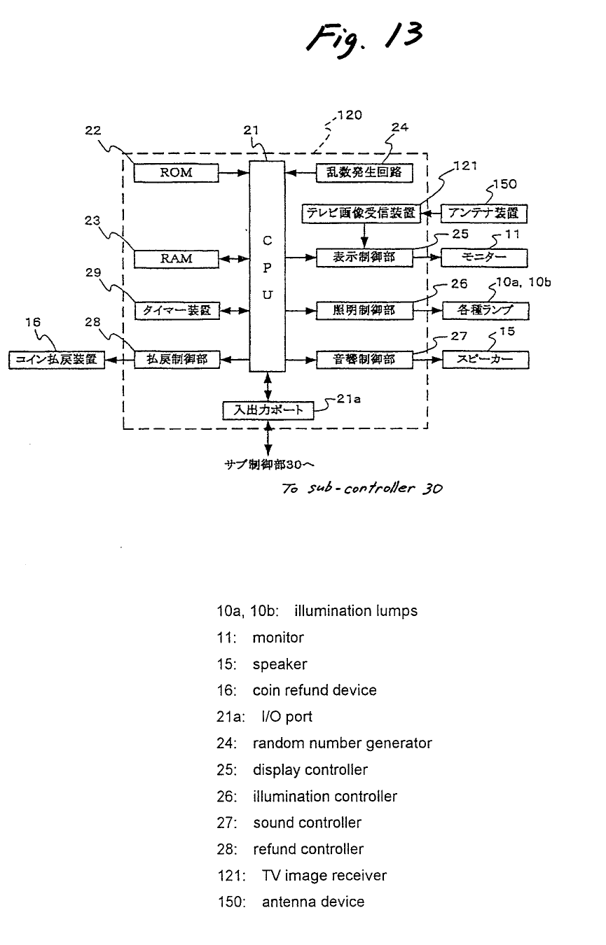

FIG. 12 is a flowchart showing the flow of excessive gaming inhibition processing according to this embodiment.

Here, when the number of games A reaches the specified number of games B (S4), gaming interruption processing is performed (S5). Subsequently, the display controller 25 displays a gaming inhibition screen on the monitor 11 in place of the reel images 11a (S7). In the present modification, there is performed report processing for informing an attendant that the number of games A played by the player has reached the specified number of games B (S101). Through the report processing, the CPU 21 of the main controller 20 outputs to the sound controller 27 a sound output instruction for providing an announcement stating that the number of games A played by the player has reached the specified number of games B, in the form of sound information. As a result, the sound controller 27 controls the speaker 15, to thereby output the announcement based on the sound output instruction in the form of voice. Upon listening to the announcement, the player of the slot machine 1 realizes that the number of games A played has reached the specified number of games B. Here, in conjunction with voice announcement or in place of voice announcement, for example, special lamps may be illuminated; a predetermined signal may be output to a radio held by an attendant; and a predetermined signal may be output to the management system 40, whereupon the management system informs an attendant that the player of the slot machine 1 has reached the specified number of games B.

The attendant who has received the announcement inserts a special key into the reset switch 12 provided on the side face of the slot machine 1 and turns the key. When the reset switch 12 is actuated in this way (S102), the CPU 21 of the main controller 20 resets the game number data recorded in the RAM 23 to a value of “0” (S10), thus performing interruption canceling processing (S11).

The present embodiment has described a case where interruption of gaming is cancelled by an attendant actuating the reset switch 12. However, the slot machine 1 may be constructed such that the player can cancel interruption for himself. For example, when the player actuates one of the other operation buttons 8 while a gaming inhibition image is appearing on the screen, the CPU 21 receives the operation signal and resets the game number data recorded in the RAM 23 to a value of “0” (S10), thus performing interruption canceling processing (S11).

There will now be described a tenth embodiment of the invention. The present embodiment is identical with the first embodiment, except that a currently-televised TV broadcast is displayed in place of the gaming inhibition image based on the gaming inhibition data recorded on the ROM 22 of the main controller 20. Hence, only a feature particular to the second embodiment will be described.

FIG. 13 is a block diagram showing the flow of excessive gaming inhibition processing according to this embodiment. The sub-controller 30 is identical with that described in connection with the first embodiment. In addition to the configuration of the main controller 20 according to the first embodiment, the main controller 120 according to the present embodiment has a TV image receiver 121 for receiving TV image information about TV broadcast. The main controller 120 is connected to the display controller 25. Further, the TV image receiver 121 is also connected to an antenna unit 150 which is provided outside the slot machine 1 and receives a TV radio wave. The antenna unit 150 sends TV image information included in the received radio waves to the TV image receiver 121. The TV image receiver 121 sends the TV image information to the display controller 25. In accordance with control of the CPU 21, the display controller 25 can display TV images on the monitor 11 on the basis of the TV image information received from the TV image receiver 121.

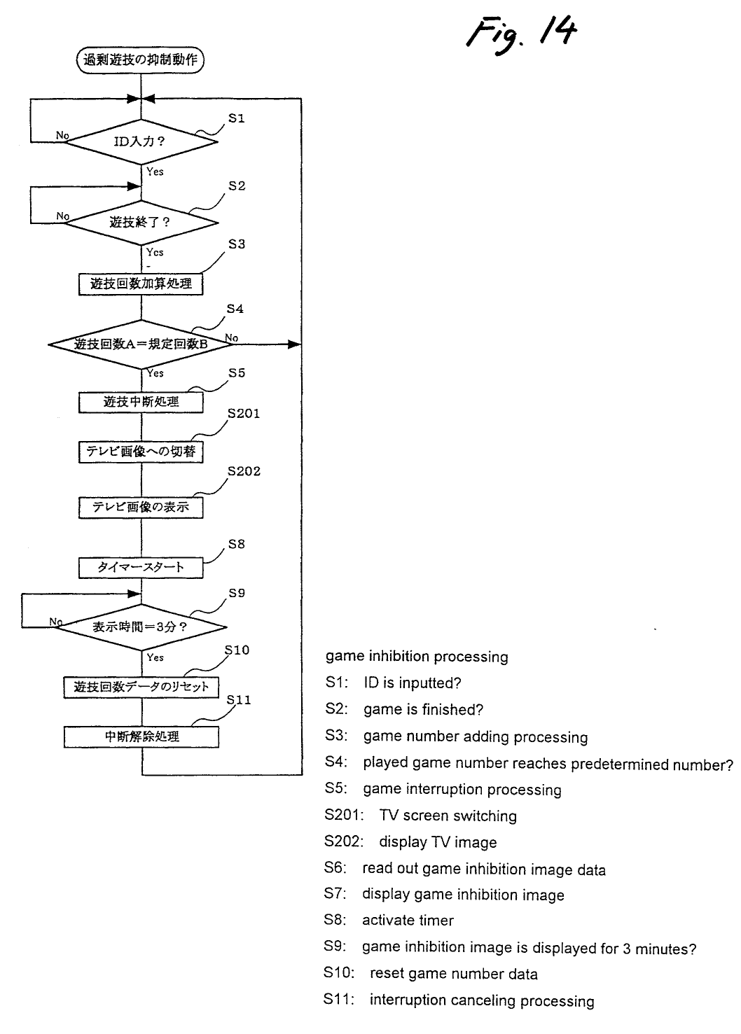

FIG. 14 is a flowchart showing the flow of excessive gaming inhibition processing according to this embodiment. As in the case of the first embodiment, after the number of games A has been determined to have reached the specified number of games B (S4), gaming interruption processing is performed (S5). Subsequently, the CPU 21 outputs, to the display controller 25, a display changeover instruction for switching the display on the monitor 11 from game images, such as the reel images 11a, to a TV image. Upon receiving the display changeover instruction, the display controller 25 performs display control operation for displaying, on the monitor 11, a TV image based on the TV image information received from the TV image receiver 121 (S201). As a result, a TV image currently being broadcast appears on the monitor 11 (S202). Subsequently, the timer 29 measures a display time period (S8 and S9). When three minutes have elapsed, the game number data are reset (S10), thus canceling interruption of gaming (S11).

The tenth embodiment has described a case where the slot machine 1 is connected directly to the antenna unit 150. However, in a casino where a plurality of slot machines 1 are installed, the slot machine 1 may be constructed such that the antenna unit 150 is connected to the management system 40 and such that the management system 40 distributes TV image information to the slot machines 1.

The embodiments and modifications have been described by taking, as an example, the slot machine 1 installed in a casino. However, the present invention is not limited to such an example. The present invention can be applied to a variety of gaming machines, such as slingshot machines or slot machines installed in parlors, arcade gaming machines to be installed in amusement arcades, and home TV game machines.

The embodiments and modifications have described the cases where sound information, such as gaming inhibition image data and sound announcement, and data to be used in gaming inhibition processing are stored in the ROM 22 and where the data are employed. Data recorded on a recording medium, such as a hard disk, a CD-ROM, a DVD, or a magnetic tape, may also be utilized. In this case, the recording medium does not need to be provided in the slot machine 1. For instance, the recording medium may be provided in the management system 40 so as to be utilized by way of the communications system.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A gaming machine, comprising:
operating members actuated by human;
a game processor, which proceeds a game in accordance with the actuation of the operating members;
an inhibition requirement determinant, which determines whether a predetermined inhibition requirement is satisfied while the game processor proceeds the game;
a game inhibiter, which performs game inhibition processing for diverting an attention of the player toward something other than the game, when the inhibition requirement determinant determines that the inhibition requirement is satisfied; and
a game interrupter, which interrupts the game proceeded by the game processor, when the inhibition requirement determinant determines that the inhibition requirement is satisfied, the game interrupter interrupting the game until a predetermined interruption canceling requirement is satisfied.

2. The gaming machine as set forth in claim 1, further comprising a timer which measures a time period that the game interrupter interrupts the game, wherein the interruption canceling requirement is that the timer measures a predetermined time period.

3. The gaming machine as set forth in claim 1, wherein:
the operating members include an inhibition canceller; and
the interruption canceling requirement is that the inhibition canceller is actuated.

4. The gaming machine as set forth in claim 1, wherein:
the operating members include a game starter which instructs the game processor to start proceeding the game; and
the game interrupter includes an operation canceller which cancels the instruction of the game starter.

5. The gaming machine as set forth in claim 1, further comprising a gaming value accepter which accepts a gaming value from a player, wherein:
the game processor proceeds the game while consuming the gaming value; and
the game interrupter includes an acceptance refuser which refuses to accept a gaming value from the player via the gaming value accepter.

6. The gaming machine as set forth in claim 1, further comprising a sound generator which generates sound for presenting the game proceeded by the game processor,
wherein the game interrupter includes a sound inhibiter which disables the sound generation of the sound generator.

7. The gaming machine as set forth in claim 1, further comprising a light emitter which emits light for presenting the game proceeded by the game processor,
wherein the game interrupter includes an illumination inhibiter which disables the light emission of the light emitter.

8. The gaming machine as set forth in claim 1, further comprising:
a gaming value recording medium, which stores therein an amount of a gaming value possessed by a player; and
a payout provider, which provides a payout to the player, the payout being a gaming value corresponding to the amount of the gaming value stored in the gaming value recording medium, wherein:
the operating members includes a payout requester which instructs the payout provider to provide the payout; and
the payout requester and the payout provider are enabled even when the game interrupter interrupts the game.

9. A method of interrupting a game performed in a gaming machine to inhibit an excessive play of a player on the gaming machine, comprising the steps of:
proceeding the game on the gaming machine;
determining whether a predetermined inhibition requirement is satisfied while the game is proceeded;
diverting an attention of the player toward something other than the game, when the inhibition requirement is satisfied;
interrupting the game when the inhibition requirement is satisfied; and
interrupting the game until a predetermined interruption canceling requirement is satisfied.

10. The game interruption method as set forth in claim 9, further comprising the step of measuring a time period that the game is interrupted,
wherein the interruption canceling requirement is that a predetermined time period is measured.

11. A program for causing a computer to execute the game interruption method as set forth in claim 9 or 10.
